(19) United States
(12) Patent Application Publication
(10) Pub. No.: US 2025/0261219 A1
(43) Pub. Date: Aug. 14, 2025

(54) DETECTION CAPABILITY DETERMINATION METHOD AND APPARATUS, DEVICE, AND STORAGE MEDIUM

(71) Applicant: GUANGDONG OPPO MOBILE TELECOMMUNICATIONS CORP., LTD., Dongguan (CN)

(72) Inventors: Bin LIANG, Dongguan (CN); Yi ZHANG, Dongguan (CN)

(73) Assignee: GUANGDONG OPPO MOBILE TELECOMMUNICATIONS CORP., LTD., Dongguan (CN)

(21) Appl. No.: 19/193,831

(22) Filed: Apr. 29, 2025

Related U.S. Application Data
(63) Continuation of application No. PCT/CN2022/130138, filed on Nov. 4, 2022.

(51) Int. Cl. H04W 72/51; H04L 27/26; H04W 72/12; H04W 72/231

(52) U.S. Cl. CPC H04W 72/51; H04L 27/26025; H04W 72/12; H04W 72/231

(57) ABSTRACT

A method and apparatus for determining a detection capability as well as a storage medium are provided. The method includes that: a detection capability parameter value for detecting a first DCI format is determined based on a first detection capability parameter value and a second detection capability parameter value. The first DCI format is used for scheduling multiple carriers in a first carrier set. The first detection capability parameter value is a single carrier detection capability parameter threshold corresponding to a first carrier. The first carrier is included in the first carrier set. The second detection capability parameter value is a detection capability parameter threshold for detecting a DCI format scheduling carrier(s) in a second carrier set. The second carrier set includes the first carrier set.

### CROSS-REFERENCE TO RELATED APPLICATION(S)

This application is a continuation of International Application No. PCT/CN2022/130138 filed on Nov. 4, 2022, the entire contents of which are hereby incorporated by reference in their entireties.

### RELATED ART

In a multi-carrier scenario, one piece of Downlink Control Information (DCI) or one Physical Downlink Control Channel (PDCCH) can schedule one carrier. If a large number of carriers are configured or a large number of DCIs or PDCCHs needs to be transmitted simultaneously, it will lead to a shortage of PDCCH resources. In order to reduce PDCCH load, it is usually necessary to use one DCI or one PDCCH to schedule multiple carriers.

Based on this, if one DCI or one PDCCH can schedule multiple carriers, how to determine the detection capability allocated for detecting the DCI or PDCCH scheduling multiple carriers is an urgent problem to be solved.

### SUMMARY

Embodiments of the present disclosure relate to the field of communication technologies, and provide a method and an apparatus for determining a detection capability, and a storage medium.

In a first aspect, the embodiments of the present disclosure provide a method for determining a detection capability. The method includes the following operation.

A detection capability parameter value for detecting a first DCI format is determined based on a first detection capability parameter value and a second detection capability parameter value. The first DCI format is used for scheduling multiple carriers in a first carrier set.

The first detection capability parameter value is a single carrier detection capability parameter threshold corresponding to a first carrier. The first carrier is included in the first carrier set.

The second detection capability parameter value is a detection capability parameter threshold for detecting a DCI format scheduling carrier(s) in a second carrier set. The second carrier set includes the first carrier set.

In a second aspect, the embodiments of the present disclosure provide an apparatus for determining a detection capability. The apparatus includes a processor and a memory.

The memory is configured to store a computer program that, when executed by the processor of the apparatus, causes the apparatus to determine, based on a first detection capability parameter value and a second detection capability parameter value, a detection capability parameter value for detecting a first DCI format. The first DCI format is used for scheduling multiple carriers in a first carrier set.

The first detection capability parameter value is a single carrier detection capability parameter threshold corresponding to a first carrier. The first carrier is included in the first carrier set.

The second detection capability parameter value is a detection capability parameter threshold for detecting a DCI format scheduling carrier(s) in a second carrier set. The second carrier set includes the first carrier set.

In a third aspect, the embodiments of the present disclosure provide a non-transitory computer readable storage medium configured to store a computer program that, when executed by a processor, causes the processor to determine, based on a first detection capability parameter value and a second detection capability parameter value, a detection capability parameter value for detecting a first DCI format. The first DCI format is used for scheduling multiple carriers in a first carrier set.

The first detection capability parameter value is a single carrier detection capability parameter threshold corresponding to a first carrier. The first carrier is included in the first carrier set.

The second detection capability parameter value is a detection capability parameter threshold for detecting a DCI format scheduling carrier(s) in a second carrier set. The second carrier set includes the first carrier set.

### BRIEF DESCRIPTION OF THE DRAWINGS

The accompanying drawings described herein are intended to provide a further understanding of the present disclosure and constitute a part of the present disclosure. The schematic embodiments of the present disclosure and the description thereof are intended to explain the present disclosure, and do not constitute an undue limitation of the present disclosure.

FIG. 1 is a schematic diagram of an exemplary network architecture according to an embodiment of the present disclosure.

FIG. 2 is a schematic flowchart of a method for determining a detection capability according to an embodiment of the present disclosure.

FIG. 3 is a schematic flowchart of another method for determining a detection capability according to an embodiment of the present disclosure.

FIG. 4 is a schematic diagram of a structural composition of an apparatus for determining a detection capability according to an embodiment of the present disclosure.

FIG. 5 is a schematic structural diagram of a communication device according to an embodiment of the present disclosure.

FIG. 6 is a schematic structural diagram of a chip according to an embodiment of the present disclosure.

FIG. 7 is a schematic block diagram of a communication system according to an embodiment of the present disclosure.

### DETAILED DESCRIPTION

Hereinafter, the technical solutions in the embodiments of the present disclosure will be described with reference to the accompanying drawings in the embodiments of the present disclosure. It is apparent that the described embodiments are part of the embodiments of the present disclosure, but not all the embodiments. Based on the embodiments in the present disclosure, all other embodiments obtained by those skilled in the art without creative work fall within the scope of protection of the present disclosure.

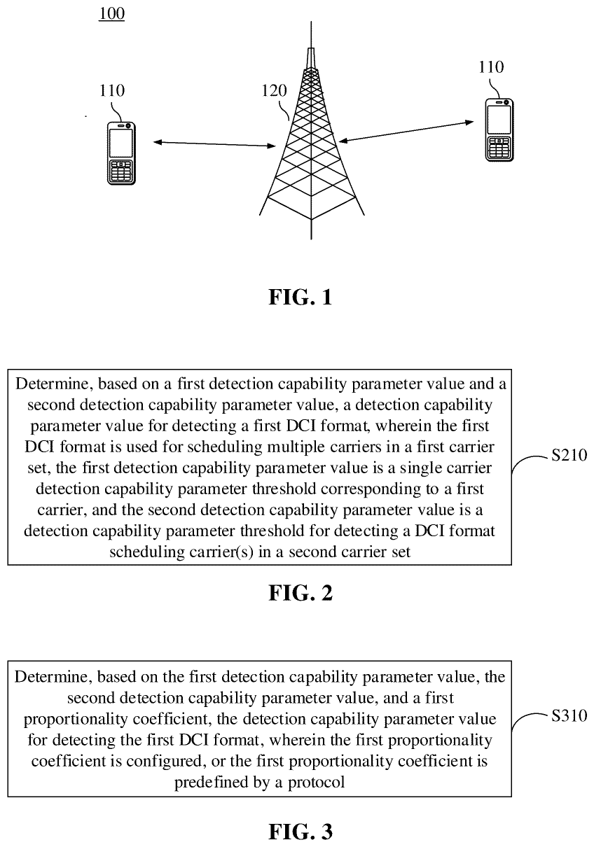

FIG. 1 is a schematic diagram of an exemplary network architecture according to an embodiment of the present disclosure.

As illustrated in FIG. 1, a communication system 100 may include terminal devices 110 and a network device 120. The network device 120 may communicate with the terminal device 110 through an air interface. Multi-service transmission is supported between the terminal devices 110 and the network device 120.

It should be understood that the embodiments of the present disclosure are only illustrated with reference to the communication system 100, but the embodiments of the present disclosure are not limited thereto. That is, the technical solutions in the embodiments of the present disclosure may be applied to various communication systems, such as a Long Term Evolution (LTE) system, an LTE Time Division Duplex (TDD), a Universal Mobile Telecommunication System (UMTS), an Internet of Things (IoT) system, a Narrow Band Internet of Things (NB-IoT) system, an enhanced Machine-Type Communications (eMTC) system, a 5G communication system (also referred to as a New Radio (NR) communication system), or future communication systems.

In the communication system 100 illustrated in FIG. 1, the network device 120 may be an access network device that communicates with the terminal devices 110. The access network device may provide communication coverage for a particular geographic area and may communicate with terminal devices 110 (for example, User Equipment (UE)) located within the coverage area.

The network device 120 may be an Evolutional Node B (eNB or eNodeB) in a LTE system, a Next Generation Radio Access Network (NG RAN) device, a base station (gNB) in an NR system, a wireless controller in a Cloud Radio Access Network (CRAN), a relay station, an access point, a vehicle-mounted device, a wearable device, a hub, a switch, a bridge, a router, or a network device in a future evolved Public Land Mobile Network (PLMN), or the like.

The terminal device 110 may be any terminal device including, but not limited to, terminal devices connected to the network device 120 or other terminal devices in a wired or wireless manner.

For example, the terminal device 110 may refer to an access terminal, a UE, a subscriber unit, a subscriber station, a mobile station, a remote station, a remote terminal, a mobile device, a user terminal, a terminal, a wireless communication device, a user agent, or a user device. The access terminal may be a cellular telephone, a cordless telephone, a Session Initiation Protocol (SIP) telephone, an IoT device, a satellite handheld terminal, a Wireless Local Loop (WLL) station, a Personal Digital Assistant (PDA), a handheld device with a wireless communication function, a computing device or other processing device connected to a wireless modem, a vehicle-mounted device, a wearable device, a terminal device in a 5G network, or a terminal device in a future evolution network, or the like.

The terminal device 110 may be used for Device to Device (D2D) communication.

The respective functional units in the communication system 100 may also establish connections with each other through next generation (NG) network interfaces for communication.

FIG. 1 illustrates one network device and two terminal devices. In some embodiments, the wireless communication system 100 may include multiple network devices, and another number of terminal devices can be included in the coverage range of each network device, which is not limited by the embodiments of the present disclosure.

It should be noted that FIG. 1 only illustrates a system applicable to the present disclosure in the form of an example, and of course, the methods in the embodiments of the present disclosure may also be applied to other systems. In addition, the terms “system” and “network” are used interchangeably herein.

It should be understood that the term “and/or” in the embodiments of the present disclosure is only used for describing an association relationship between association objects, which indicates that there may be three kinds of relationships. For example, A and/or B may indicate the following three cases: A exists alone, A and B exist simultaneously, and B exists alone. In addition, the character “/” in the present disclosure generally indicates that there is an “or” relationship between the association objects.

It should also be understood that the “predefined” or “predefined rules” mentioned in the embodiments of the present disclosure may be implemented by storing corresponding codes, tables, or other methods that may be used to indicate relevant information in advance in devices (such as, including a terminal device and network device), and specific implementations thereof are not limited in the present disclosure. For example, “predefined” may refer to be defined in a protocol. It should also be understood that in the embodiments of the present disclosure, the “protocol” may refer to a standard protocol in the field of communications, and may include, for example, an LTE protocol, an NR protocol, and related protocols applied to future communication systems, which are not limited in the present disclosure.

In the 5G communication system, the terminal device may determine, based on carriers configured by the network device, the maximum Physical Downlink Control Channel (PDCCH) detection capability supported by each scheduled carrier in a scheduling carrier corresponding to the scheduled carrier. The PDCCH detection capability may be the number of PDCCH blind detections, the number of PDCCH candidates for the blind detection, or the number of non-overlapping Control Channel Elements (CCEs) for the channel estimation.

In some embodiments, when a total detection capability parameter value of a scheduling carrier with a subcarrier spacing configuration of u is denoted as M_total, the calculation formula for M_total satisfies the formula (1).

$$M\_total = ⌊ {N}_{cells}^{cap} \cdot M\_max \cdot ( {N}_{cells , 0}^{DL , μ} + γ \cdot {N}_{cells , 1}^{DL , μ} ) / {\sum }_{j = 0}^{3} ( {N}_{cells , 0}^{DL , j} + γ \cdot {N}_{cells , 1}^{DL , j} ) ⌋ \qquad ( 1 )$$

Here, N^{cap}_{Vcells} is the number of carriers that are supported for detection by the terminal device, M_max is a single-carrier PDCCH detection capability parameter value, N_{cells,0}^{DL,μ}+γ·N_{cells,1}^{DL,μ} is the carrier quantity of scheduled carriers corresponding to a scheduling carrier with the subcarrier spacing configuration of u, and Σⱼ₌₀³(N_{cells,0}^{DL,j}+γ·N_{cells,1}^{DL,j}) is a sum of the carrier quantities of scheduled carriers corresponding to scheduling carriers with the subcarrier spacing configurations of j.

Based on the formula (1), the maximum PDCCH detection capability parameter value supported by each scheduled carrier in a scheduling carrier corresponding to the scheduled carrier, i.e., min(M_max, M_total), can be determined.

In a multi-carrier scenario, one DCI/PDCCH can schedule one carrier, and if a large number of carriers are configured or a large number of DCIs or PDCCHs needs to be transmitted simultaneously, it will result in a shortage of PDCCH resources. In order to reduce PDCCH load, it is usually necessary to use one DCI/PDCCH to schedule multiple carriers. The combination of carriers scheduled by the same DCI/PDCCH is preconfigured or predefined.

In some embodiments, the detection capability for a DCI/PDCCH that can schedule multiple carriers is attributed to one carrier in all carriers that can be scheduled by the DCI.

It should be noted that if one DCI/PDCCH can schedule multiple carriers, how to determine the detection capability allocated for detecting the DCI/PDCCH scheduling multiple carrier is an urgent problem to be solved.

Based on this, the embodiments of the present disclosure provide a method for determining a detection capability. In the method, a detection capability parameter value for detecting a first DCI format is determined based on a first detection capability parameter value and a second detection capability parameter value, where the first DCI format is used for scheduling multiple carriers in a first carrier set. In this way, the detection capability parameter value for the first DCI format scheduling multiple carriers can be determined based on the first detection capability parameter value and the second detection capability parameter value. As a result, the detection capability for the DCI format (i.e., the first DCI format) scheduling multiple carriers is clarified, which can further optimize the blind detection process of the terminal device. In addition, the terminal device can determine, by using the method, the detection capability parameter value for detecting the first DCI format, such as the number of blind detections, the number of PDCCH candidates for the blind detection, and/or the number of non-overlapping CCEs for channel estimation. The network device determines, by using the method, the detection capability parameter value for detecting the first DCI format by the terminal device, which is helpful for the network device to configure the appropriate number of PDCCH transmission resources, such as the number of Control Resource Sets (CORESETs), the number of Search Space Sets or the number of PDCCH candidates. This ensures that the number of PDCCHs that can be transmitted does not exceed the detection capability of the terminal device, thereby avoiding situations that some PDCCHs cannot be detected/monitored due to an insufficient detection capability of terminal device, and improving the system performance.

For example, it can be ensured that the scheduling information is not lost, so that the terminal device can perform data transmission in time. It is ensured that the channel feedback request indication is not lost, so that the terminal device can report the channel state measurement result in time, and the network device can adjust the scheduling parameter in time based on the changes in channel state.

It should be noted that in the following embodiments, the first DCI format and the second DCI format are mentioned multiple times. A DCI format that can be used for scheduling multiple carriers is denoted as the first DCI format, such as a DCI format 0_X and/or 1_X. A DCI format that can be used for scheduling one carrier is denoted as the second DCI format, such as a DCI format 0_0/0_1/0_2/1_0/1_1/1_2.

It should also be noted that the performing entity in the embodiments of the present disclosure may be a network device or a terminal device, and the performing entity is not specifically limited in the embodiments of the present disclosure.

In order to facilitate understanding of the technical solutions in the embodiments of the present disclosure, the technical solutions of the present disclosure will be described in detail below with reference to specific embodiments. The above related technologies, serving as optional solutions, may be arbitrarily combined with the technical solutions in the embodiments of the present disclosure, and the technical solutions obtained by the combinations belong to the scope of protection of the embodiments of the present disclosure. Embodiments of the present disclosure include at least part of the following contents.

FIG. 2 is a schematic flowchart of a method for determining a detection capability according to an embodiment of the present disclosure. As illustrated in FIG. 2, the method may include the following contents.

In operation S210, a detection capability parameter value for detecting a first DCI format is determined based on a first detection capability parameter value and a second detection capability parameter value. The first DCI format is used for scheduling multiple carriers in a first carrier set. The first detection capability parameter value is a single carrier detection capability parameter threshold corresponding to a first carrier. The second detection capability parameter value is a detection capability parameter threshold for detecting a DCI format scheduling carrier(s) in a second carrier set.

The first carrier is one carrier in the first carrier set.

For example, if the first carrier set is {cell1, cell2, cell3, cell4}, the first carrier may be one of cell1, cell2, cell3, and cell4.

Exemplarily, the first carrier is any one of the following in the first carrier set: a carrier with Identity (ID) information being a specified ID, a carrier whose number of configured search space sets satisfies a first preset rule, a carrier whose number of search space sets supporting single carrier scheduling satisfies a second preset rule, a carrier configured for calculating the detection capability parameter value for the first DCI format, a carrier configured with a search space set supporting the first DCI format, a carrier counting a DCI size of the first DCI format, or a carrier predefined by a protocol.

It should be noted that the carrier with the ID information being the specific ID may be a carrier with the smallest cell ID in the first carrier set, or a carrier with the largest cell ID in the first carrier set, or a carrier with another cell ID in the first carrier set, which is not limited in the embodiments of the present disclosure.

It should also be noted that the first preset rule is that the number of configured search pace sets is the minimum, or the number of configured search space sets is the maximum. The second preset rule is that the number of configured search space sets supporting single carrier scheduling is the minimum, or the number of configured search space sets supporting single carrier scheduling is the maximum, which is not limited in the embodiments of the present disclosure.

It should be noted that the carrier whose number of configured search space sets satisfies the first preset rule may be the carrier whose number of configured search space sets is the minimum, or may be the carrier whose number of configured search space sets is another value, which is not limited in the embodiments of the present disclosure.

It should be noted that the carrier whose number of search space sets supporting single carrier scheduling satisfies the second preset rule may be the carrier whose number of configured search space sets supporting single carrier scheduling is the minimum, or may be the carrier whose number of configured search space sets supporting single carrier scheduling is another value, which is not limited in the embodiments of the present disclosure.

It should be noted that the carrier configured for calculating the detection capability for the first DCI format may be a carrier, configured by the network device through a Radio Resource Control (RRC) signaling, for calculating the detection capability for the first DCI format, or may be a carrier, configured by the network device through another signaling, for calculating the detection capability for the first DCI format, which is not limited in the embodiments of the present disclosure.

The second carrier set includes the first carrier set.

It should be understood that for the terminal device, the second carrier set may be configured to the terminal device by the network device.

It should be understood that for the terminal device, the second carrier set is determined based on carriers allocated to the terminal device. Subcarrier spacings of scheduling carriers corresponding to carriers in the second carrier set are the same, and the second carrier set includes the first carrier set.

It should also be understood that the DCI format scheduling the carrier(s) in the second carrier set may be a DCI format for scheduling multiple carriers or a DCI format for scheduling a single carrier.

It should also be understood that the first detection capability parameter value may be the maximum detection capability parameter value supported by the first carrier when a subcarrier spacing configuration is u.

In some embodiments, the operation of determining, based on the first detection capability parameter value and the second detection capability parameter value, the detection capability parameter value for detecting the first DCI format may include determining, based on a minimum one of the first detection capability parameter value and the second detection capability parameter value, the detection capability parameter value for detecting the first DCI format.

Exemplarily, the first detection capability parameter value is denoted as M_max and the second detection capability parameter value is denoted as M_total, in this case, the detection capability parameter value for detecting the first DCI format by the terminal device or the network device may be the minimum one of M_max and M_total, i.e., min(M_max, M_total).

In some embodiments, subcarrier spacings of scheduling carriers for carriers in the second carrier set are same.

It should be noted that the scheduling carrier is a carrier that can schedule other carriers. In this case, the other carriers are referred to as scheduled carriers. For example, it is assumed that cell1 is a scheduling carrier, cell1 may schedule itself, and cell1 may also schedule cell2. Thus, cell1 is not only a scheduling carrier, but also a scheduled carrier, and cell2 is a scheduled carrier.

It should also be noted that for multiple scenarios, there may be multiple scheduling carriers for the scheduled carriers. In the current scenario, there is the unique scheduling carrier for the scheduled carriers.

Exemplarily, the second carrier set is {cell1, cell2, cell3, cell4, cell5}. It is assumed that cell1 is the scheduling carrier, the scheduling carriers for cell1, cell2, cell3, cell4, and cell5 are all cell1. In this case, the subcarrier spacings of the scheduling carriers (i.e., cell1) for cell1, cell2, cell3, cell4, and cell5 are the same, and are all the subcarrier spacing of cell1.

In some embodiments, the first detection capability parameter value may be a single carrier PDCCH detection capability parameter value corresponding to the first carrier.

In some embodiments, the first detection capability parameter value may be determined based on a subcarrier spacing of the first carrier, or the first detection capability parameter value may be determined based on a subcarrier spacing of a scheduling carrier for the first carrier.

Exemplarily, according to the predefinition in the protocol, there is a correspondence between the subcarrier spacing of the first carrier and the first detection capability parameter value. For example, there is a one-to-one correspondence between the subcarrier spacing of the first carrier and the first detection capability parameter value, and the first detection capability parameter value may be uniquely determined based on the subcarrier spacing of the first carrier.

Exemplarily, according to the predefinition in the protocol, there is a correspondence between the subcarrier spacing of the scheduling carrier for the first carrier and the first detection capability parameter value. For example, there is a one-to-one correspondence between the subcarrier spacing of the scheduling carrier for the first carrier and the first detection capability parameter value, and the first detection capability parameter value may be uniquely determined based on the subcarrier spacing of the scheduling carrier for the first carrier.

It should be understood that when the first carrier is used as the scheduling carrier, the first detection capability parameter value may be determined based on the subcarrier spacing of the scheduling carrier, that is, the subcarrier spacing of the first carrier itself.

Exemplarily, it is assumed that the first carrier set is {cell1, cell2, cell3, cell4}, the first carrier is cell1, and cell1 is the scheduling carrier, the first detection capability parameter value may be determined based on the subcarrier spacing of cell1.

It should also be understood that when the first carrier is used as the scheduled carrier, the first detection capability parameter value may be determined based on the subcarrier spacing of the scheduled carrier, that is, the subcarrier spacing of the first carrier itself, or the first detection capability parameter value may be determined based on the subcarrier spacing of the scheduling carrier for the scheduled carrier.

Exemplarily, it is assumed that the first carrier set is {cell1, cell2, cell3, cell4}, the first carrier is cell1, and the scheduling carrier is cell2. Thus, cell2 is not only the scheduling carrier, but also the scheduled carrier, and cell1 is the scheduled carrier. In this case, the first detection capability parameter value may be determined based on the subcarrier spacing of cell 1, or the first detection capability parameter value may be determined based on the subcarrier spacing of the scheduling carrier cell 2 for cell 1.

In some embodiments, the second detection capability parameter value may be determined based on the number of carriers that are supported for detection, and configured multiple carriers.

It should be noted that the number of carriers that are supported for detection by the terminal device may be reported to the network device through a signaling, and the network device may determine the number of carriers that are supported for detection by the terminal device based on the reported value.

Further, in some embodiments, the second detection capability parameter value is determined based on the number of carriers that are supported for detection, the single carrier detection capability parameter threshold, a first value, and a second value.

The first value is determined based on a carrier quantity corresponding to the second carrier set, where the carrier quantity corresponding to the second carrier set is determined based on count values of carriers.

The second value is determined based on a carrier quantity of the configured multiple carriers, where the carrier quantity of the configured multiple carriers is determined based on count values of the carriers, and the configured multiple carriers include the second carrier set.

It should be noted that in the embodiments of the present disclosure, the carrier quantity and the number of carriers are not necessarily the same.

For example, it is assumed that there are three carriers in a carrier set (such as the first carrier set or the second carrier set), and the count value of each carrier in the three carriers is 1. In this case, the carrier quantity corresponding to the set may be determined to be 3 based on the count value of each carrier in the three carriers.

For another example, it is assumed that there are three carriers in a carrier set, the count value of one carrier of the three carriers is 2, and the count values of the remaining two carriers are 1. In this case, the carrier quantity corresponding to the set is 4.

For another example, it is assumed that there are three carriers in a carrier set, the count value of one carrier of the three carriers is 2, and the count values of the remaining two carriers are 1.5. In this case, the carrier quantity corresponding to the set is 5.

Exemplarily, the second detection capability parameter value may be determined based on the number of carriers that are supported for detection, a sum of count values of carriers in the second carrier set, and a sum of count values of the configured multiple carriers.

Further, for example, the second detection capability parameter value may be determined based on the number of carriers that are supported for detection, the first detection capability parameter value, the sum of count values of carriers in the second carrier set, and the sum of count values of the configured multiple carriers.

The configured multiple carriers may include the second carrier set.

It should be understood that the sum of the count values of the configured multiple carriers includes the sum of the count values of the carriers in the second carrier set.

Exemplarily, it is assumed that u is the subcarrier spacing configuration, which may be taken one of the values 0, 1, 2, or 3.

It should be understood that the values of u are only used to distinguish different subcarrier spacings, and do not represent the actual subcarrier spacings. For example, the value 0 of μ may correspond to a subcarrier spacing of 15 KHz, the value 1 of μ may correspond to a subcarrier spacing of 30 KHz, the value 2 of μ may correspond to a subcarrier spacing of 60 KHz, and the value 3 of μ may correspond to a subcarrier spacing of 120 KHz.

Exemplarily, the subcarrier spacing configurations of scheduling carriers for the carriers in the second carrier set are all 0, and the sum of the count values of the carriers in the second carrier set is recorded as N_{cells}^{DL,0} In this case, the sum of the count values of the configured multiple carriers may be the sum of N_{cells}^{DL,0}, N_{cells}^{DL,1}, N_{cells}^{DL,2} and N_{cells}^{DL,3}, i.e., Σⱼ₌₀³(N_{cells}^{DL,j}).

It should also be noted that the count values of the carriers in the second carrier set may be the count values of the scheduled carriers for the scheduling carrier with the subcarrier spacing configuration of u.

Exemplarily, it is assumed that the second carrier set is {cell1, cell2, cell3, cell4} and cell1 is the scheduling carrier. In this case, cell1, cell2, cell3, and cell4 are all scheduled carriers, and the scheduling carriers for cell1, cell2, cell3, and cell4 are all cell1. It is assumed that the subcarrier spacing configuration of cell1 is u, then the subcarrier spacings of the scheduling carriers (i.e., cell1) for cell1, cell2, cell3, and cell4 are all u. That is, the scheduled carriers for the scheduling carrier (i.e. cell1) with the subcarrier spacing configuration of μ are cell1, cell2, cell3, and cell4. In this case, the count values of the carriers in {cell1, cell2, cell3, and cell4} are the count values of cell1, cell2, cell3, and cell4.

It should also be understood that the number of carriers that are supported for detection is the number of carriers that are supported for detection by the terminal device, and may be used to characterize the PDCCH detection carrier capability reported by the terminal device. The terminal device may report, to the network device, the number of carriers that are supported for detection.

It should also be understood that the configured multiple carriers is multiple carriers configured by the network device, and the network device may configure multiple carriers for the terminal device.

It should be noted that in the embodiments of the present disclosure, the count value may be understood as a weight value. For example, the count value of cell1 is 2, which means that the weight value of cell1 is 2, and does not mean the actual number of cell1.

In some embodiments, the count values of the configured multiple carriers may be used to characterize the degree of influence of the carriers on the second detection capability parameter value. That is, when the count values of the configured multiple carriers are different, the obtained second detection capability parameter values will also differ.

In some embodiments, the count values of the configured multiple carriers may be determined by the following two possible implementations.

In a possible implementation, the count values of the configured multiple carriers may be as follows. A count value of the first carrier is 1+x. Count values of other carriers, other than the first carrier, in the configured multiple carriers are determined according to any one of: the count values are all 1−y, the count values are all 1−x/(M−1), or the count values are all 1−x/(N−1).

Specifically, in some embodiments, the count values of the configured multiple carriers may be further determined according to any one of the following (a), (b), (c), (d), (e), or (f).

(a) The count value of the first carrier is 1, and the count values of other carriers are all 1.

It should be noted that in this case, the detection capability parameter value for detecting the first DCI format by the terminal device or the network device is attributed to the first carrier, and has no influence on other carriers.

(b) The count value of the first carrier is 2, and the count values of other carriers are all 1.

It should be noted that in this case, the first carrier set is regarded as one carrier, sharing the detection capability parameter value with other carriers.

(c) The count value of the first carrier is 1+x, and the count values of other carriers are all 1.

It should be noted that in this case, the first carrier set is regarded as one carrier, but the influence on the detection capability parameter values of other carriers is determined based on x.

(d) The count value of the first carrier is 1+x, and the count values of other carriers are all 1−y.

It should be noted that in this case, the first carrier set is regarded as one carrier, but the influence on the detection capability parameter values of other carriers is determined based on x and y.

(e) The count value of the first carrier is 1+x, and the count values of other carriers are all 1−x/(M−1).

It should be noted that in this case, the first carrier set is regarded as one carrier, but only the detection capability parameter values of other carriers in the first carrier set are affected, and the detection capability parameter values of carriers other than the first carrier set are not affected.

(f) The count value of the first carrier is 1+x, and the count values of other carriers are all 1−x/(N−1).

In another possible implementation, the count values of the configured multiple carriers may be as follows. A count value of the first carrier set is x, and the count values of the configured multiple carriers are determined according to any one of: the count values are all 1−y, the count values are all 1−x/M, or the count values are all 1−x/N.

Specifically, in some embodiments, the count values of the configured multiple carriers may be further determined according to any one of the following (g), (h), (i), (j), or (k).

(g) The count value of the first carrier set is 1, and the count values of other carriers are all 1.

(h) The count value of the first carrier set is x, and the count values of other carriers are all 1.

(i) The count value of the first carrier set is x, and the count values of other carriers are all 1−y.

(j) The count value of the first carrier set is x, and the count values of other carriers are all 1−x/M.

(k) The count value of the first carrier set is x, and the count values of other carriers are all 1−x/N.

It should be noted that in (a) to (k), x and y may be configured, or x and y may be predefined in the protocol. M and N may be configured, or M and N may be predefined in the protocol, or M may be the number of carriers in the first carrier set and N may be the number of the configured multiple carriers.

It should be noted that in the embodiments of the present disclosure, the values of x and y are not limited. x may be a positive number, a negative number, or 0. x may be an integer or a non-integer.

Exemplarily, the value of x is greater than or equal to 0 and less than or equal to 1, and/or the value of y is greater than or equal to 0 and less than or equal to 1.

It should be understood that the manners for determining the count values of the multiple carriers configured by the network device in (a) to (k) are exemplary explanations, and there may be other manners for determining the count values of the multiple carriers configured by the network device, which are not limited in the embodiments of the present disclosure.

It should also be understood that the other carriers in (a) to (k) may be carriers, other than the first carrier, in the first carrier set; or may be carriers, other than the first carrier, in the second carrier set, that is, carriers, other than the first carrier, in all carriers having the same subcarrier spacing configuration as the first carrier among the multiple carriers configured by the network device; or may be carriers, other than the first carrier, in the multiple carriers configured by the network device.

Exemplarily, in the embodiments of the present disclosure, the calculation formula for the second detection capability parameter value satisfies the formula (2).

$$M\_total = ⌊ {N}_{cells}^{cap} \cdot M\_max \cdot ( {N}_{cells}^{DL , μ} ) / {\sum }_{j = 0}^{3} ( {N}_{cells}^{DL , j} ) ⌋ \qquad ( 2 )$$

μ is the subcarrier spacing configuration, and may be taken one of the values 0, 1, 2, and 3. N_{cells}^{cap} is; the number of carriers that are supported for detection by the terminal device. M_max is the first detection capability parameter value. Nous is a sum of count values of carriers in the second carrier set. Σⱼ₌₀³(N_{cells}^{DL,j}) is a sum of count values of multiple carriers configured by the network device.

It should be noted that there may be multiple counting methods for the count values of the multiple carriers configured by the network device. The description will be made below with reference to four specific examples.

In the first example, there are four carriers in the second carrier set configured by the network device to the terminal device, which are denoted as cell1, cell2, cell3, and cell4 respectively, and the first DCI format may be configured to schedule multiple carriers in the set {cell1, cell2, cell3, cell4}. That is, the first carrier set is {cell1, cell2, cell3, cell4}, the scheduling carriers for cell1, cell2, cell3, and cell4 are all cell1, and the subcarrier spacing configurations of cell1, cell2, cell3, and cell4 are the same, where the subcarrier spacing is denoted as u. The detection capability parameter value for detecting the first DCI format by the terminal device or the network device is counted on cell1. That is, the detection capability parameter value for detecting the set {cell 1, cell 2, cell 3, cell 4} by the terminal device or the network device is counted on cell1. In this case, the count values of cell 1, cell 2, cell 3, and cell 4 may be as follows.

(1) The count values of cell1, cell2, cell3, and cell4 are all 1.

It should be noted that in this case, N_{cells}^{DL,μ}=4, and the determination of the count values of cell1, cell2, cell3, and cell4 is similar to the above (a).

(2) The count value of cell1 is 1+x, and the count values of cell2, cell3, and cell4 are all 1−(x/3).

It should be noted that in this case, N_{cells}^{DL,μ}=4, and the determination of the count values of cell1, cell2, cell3, and cell4 is similar to the above (e).

(3) The count value of cell 1 is 2, and the count values of cell 2, cell 3, and cell 4 are all 1.

It should be noted that in this case, N_{cells}^{DL,μ}=5, and the determination of the count values of cell1, cell2, cell3, and cell4 is similar to the above (b).

(4) The count value of cell1 is 1+x, and the count values of cell2, cell3, and cell4 are all 1.

It should be noted that in this case, N_{cells}^{DL,μ}=4+x, and the determination of the count values of cell1, cell2, cell3, and cell4 is similar to the above (c).

(5) The count values of cell1, cell2, cell3, and cell4 are all 1, and the count value of the set {cell1, cell2, cell3, cell4} is x.

It should be noted that in this case, N_{cells}^{DL,μ}=4+x, and the determination of the count values of cell1, cell2, cell3, and cell4 is similar to the above (h).

(6) The count value of cell1 is 1+x, and the count values of cell2, cell3, and cell4 are all 1−y.

It should be noted that in this case, N_{cells}^{DL,μ}=4+x−3*y, and the determination of the count values of cell1, cell2, cell3, and cell4 is similar to the above (d).

It should be understood that when the sum of the count values of the multiple carriers configured by the network device is calculated, that is, when Σⱼ₌₀³(N_{cells}^{DL,j}) is calculated, and when j is taken other values different from u, calculation of N_{cells}^{DL,j} is similar to that of N_{cells}^{DL,μ}, i.e., it may also be determined by one of the above methods (1) to (6). For example, when μ=0, determination of N_{cells}^{DL,1} N_{cells}^{DL,2} cells and N_{cells}^{DL,3} is similar to that of N_{cells}^{DL,0}. This will not be repeated here.

In the second example, there are four carriers in the second carrier set configured by the network device to the terminal device, which are denoted as cell1, cell2, cell3, and cell4 respectively, and the first DCI format may be configured to schedule multiple carriers in the set {cell1, cell2, cell3, cell4}. That is, the first carrier set is {cell1, cell2, cell3, cell4}, the scheduling carriers for cell1, cell2, cell3, and cell4 are all cell1, and the subcarrier spacing configurations of cell1, cell2, cell3, and cell4 are the same, where the subcarrier spacing is denoted as u. The detection capability parameter value for detecting the first DCI format by the terminal device or the network device is counted on cell1. That is, the detection capability parameter value for detecting the set {cell 1, cell 2, cell 3, cell 4} by the terminal device or the network device is counted on cell1. In this case, the count values of cell 1, cell 2, cell 3, and cell 4 may be as follows.

(1) The count values of cell1, cell2, cell3, and cell4 are all 1−x/4, and the count value of {cell1, cell2, cell3, cell4} is x.

It should be noted that in this case, N_{cells}^{DL,μ}=4, and the determination of the count values of cell1, cell2, cell3, and cell4 is similar to the above (j) or (k).

(2) The count values of cell1, cell2, cell3, and cell4 are all 1, and the count value of {cell1, cell2, cell3, cell4} is 1.

It should be noted that in this case, N_{cells}^{DL,μ}=5, and the determination of the count values of cell1, cell2, cell3, and cell4 is similar to the above (g).

(3) The count values of cell1, cell2, cell3, and cell4 are all 1, and the count value of {cell1, cell2, cell3, cell4} is x.

It should be noted that in this case, N_{cells}^{DL,μ}=4+x, and the determination of the count values of cell1, cell2, cell3, and cell4 is similar to the above (h).

(4) The count values of cell1, cell2, cell3, and cell4 are all 1−y, and the count value of {cell1, cell2, cell3, cell4} is x.

It should be noted that in this case, N_{cells}^{DL,μ}=4+x−4*y, and the determination of the count values of cell1, cell2, cell3, and cell4 is similar to the above (i).

It should be understood that when the sum of the count values of the multiple carriers configured by the network device is calculated, that is, when Σⱼ₌₀³(N_{cells}^{DL,j}) is calculated, and when j is taken other values different from μ, calculation of N_{cells}^{DL,j} is similar to that of N_{cells}^{DL,μ} i.e., it may also be determined by one of the above methods (1) to (4). For example, when μ=0, determination of N_{cells}^{DL,1} N_{cells}^{DL,2} and N_{cells}^{DL,3} is similar to that of N_{cells}^{DL,0}. This will not be repeated here.

In the third example, there are eight carriers in the second carrier set configured by the network device to the terminal device, which are denoted as cell1, cell2, cell3, cell4, cell5, cell6, cell7, and cell8, respectively, and the first DCI format may be configured to schedule multiple carriers in the set {cell1, cell2, cell3, cell4}. That is, the first carrier set is {cell1, cell2, cell3, cell4}, the scheduling carriers for cell1, cell2, cell3, and cell4 are all cell1, and the subcarrier spacing configurations of cell1, cell2, cell3, cell4, cell5, cell6, cell7, and cell8 are the same, where the subcarrier spacing is denoted as u. The detection capability parameter value for detecting the first DCI format by the terminal device or the network device is counted on cell1. That is, the detection capability parameter value for detecting the set {cell 1, cell 2, cell 3, cell 4} by the terminal device or the network device is counted on cell1. In this case, the count values of cell 1 to cell 8 may be as follows.

(1) The count values of cell1, cell2, cell3, cell4, cell5, cell6, cell7, and cell8 are all 1.

It should be noted that in this case, N_{cells}^{DL,μ}=8, and the determination of the count values of cell1 to cell8 is similar to the above (a).

(2) The count value of cell1 is 1+x, and the count values of cell2, cell3, cell4, cell5, cell6, cell7, and cell8 are all 1−(x/7).

It should be noted that in this case, N_{cells}^{DL,μ}=8, and the determination of the count values of cell1 to cell8 is similar to the above (e).

(3) The count value of cell1 is 1+x, the count values of cell2, cell3, and cell4 are all 1−(x/3), and the count values of cell5, cell6, cell7, and cell8 are all 1.

It should be noted that in this case, N_{cells}DL,μ=8, and the determination of the count values of cell1 to cell4 is similar to the above (e) and the determination of the count values of cell5 to cell8 is similar to the above (a).

(4) The count value of cell1 is 2, and the count values of cell2, cell3, cell4, cell5, cell6, cell7, and cell8 are all 1.

It should be noted that in this case, N_{cells}DL,μ=9, and the determination of the count values of cell1 to cell8 is similar to the above (b).

(5) The count value of cell1 is 1+x, and the count values of cell2, cell3, cell4, cell5, cell6, cell7, and cell8 are all 1.

It should be noted that in this case, N_{cells}^{DL,μ}=8+x, and the determination of the count values of cell1 to cell8 is similar to the above (c).

(6) The count value of cell1 is 1+x, the count values of cell2, cell3, and cell4 are all 1−y, and the count values of cell5, cell6, cell7, and cell8 are all 1.

It should be noted that in this case, N_{cells}^{DL,μ}=8+x−3*y, and the determination of the count values of cell1 to cell4 is similar to the above (d) and the determination of the count values of cell5 to cell8 is similar to the above (a).

(7) The count value of cell1 is 1+x, and the count values of cell2, cell3, cell4, cell5, cell6, cell7, and cell8 are all 1−y.

It should be noted that in this case, N_{cells}^{DL,μ}=8+x−7*y, and the determination of the count values of cell1 to cell8 is similar to the above (d).

It should be understood that when the sum of the count values of the multiple carriers configured by the network device is calculated, that is, when Σⱼ₌₀³(N_{cells}^{DL,j}) is calculated, and when j is taken other values different from u, calculation of N_{cells}^{DL,j} is similar to that of N_{cells}^{DL,μ}, i.e., it may also be determined by one of the above methods (1) to (7). For example, when μ=0, determination of N_{cells}^{DL,1}, N_{cells}^{DL,2} and N_{cells}^{DL,3} is similar to that of N_{cells}^{DL,0}. This will not be repeated here.

In the fourth example, there are eight carriers in the second carrier set configured by the network device to the terminal device, which are denoted as cell1, cell2, cell3, cell4, cell5, cell6, cell7, and cell8, respectively, cell9 is a carrier, other than the second carrier set, configured by the network device to the terminal device, and the first DCI format may be configured to schedule multiple carriers in the set {cell1, cell2, cell3, cell4}. That is, the first carrier set is {cell1, cell2, cell3, and cell4}, the scheduling carriers for cell1, cell2, cell3, and cell4 are all cell1, the subcarrier spacing configurations of cell1, cell2, cell3, cell4, cell5, cell6, cell7, and cell8 are the same, where the subcarrier spacing is denoted as u. The subcarrier spacing configuration of cell 9 is different from that of cell 1 to cell 8, where the subcarrier spacing is denoted as μ1. The detection capability parameter value for detecting the first DCI format by the terminal device or the network device is counted on cell1. That is, the detection capability parameter value for detecting the set {cell 1, cell 2, cell 3, cell 4} by the terminal device or the network device is counted on cell1. In this case, the count values of cell 1 to cell 9 may be as follows.

(1) The count values of cell1, cell2, cell3, cell4, cell5, cell6, cell7, and cell8 are all 1, and the count value of cell9 is 1.

It should be noted that in this case, N_{cells}^{DL,μ}=8 and N_{cells}^{DL,μ1}=1, and the determination of the count values of cell1 to cell8 is similar to the above (a), and the determination of the count value of cell9 is similar to the above (a).

(2) The count value of cell1 is 1+x, the count values of cell2, cell3, cell4, cell5, cell6, cell7, and cell8 are all 1−(x/7), and the count value of cell9 is 1.

It should be noted that in this case, N_{cells}^{DL,μ}=8 and N_{cells}^{DL,μ1}=1, and the determination of the count values of cell1 to cell8 is similar to the above (e) and the determination of the count value of cell9 is similar to the above (a).

(3) The count value of cell1 is 1+x, the count values of cell2, cell3, and cell4 are all 1−(x/3), the count values of cell5, cell6, cell7, and cell8 are all 1, and the count value of cell9 is 1.

It should be noted that in this case, N_{cells}^{DL,μ}=8 and N_{cells}^{DL,μ1}=1, and the determination of the count values of cell1 to cell4 is similar to the above (e), the determination of the count values of cell5 to cell8 is similar to the above (a) and the determination of the count value of cell9 is also similar to the above (a).

(4) The count value of cell1 is 1+x, the count values of cell2, cell3, cell4, cell5, cell6, cell7, and cell8 are all 1−(x/8), and the count value of cell9 is 1−(x/8).

It should be noted that in this case, N_{cells}^{DL,μ}=8+x/8 and N_{cells}^{DL,μ1}=1−x/8, and the determination of the count values of cell1 to cell8 is similar to the above (f) and the determination of the count value of cell9 is also similar to the above (f).

(5) The count value of cell1 is 2, the count values of cell2, cell3, cell4, cell5, cell6, cell7, and cell8 are all 1, and the count value of cell 9 is 1.

It should be noted that in this case, N_{cells}^{DL,μ}=9 and N_{cells}^{DL,μ1}=1, and the determination of the count values of cell1 to cell8 is similar to the above (b) and the determination of the count value of cell9 is similar to the above (a).

(6) The count value of cell1 is 1+x, the count values of cell2, cell3, cell4, cell5, cell6, cell7, and cell8 are all 1, and the count value of cell 9 is 1.

It should be noted that in this case, N_{cells}^{DL,μ}=8+x and N_{cells}^{DL,μ1}=1, and the determination of the count values of cell1 to cell8 is similar to the above (c) and the determination of the count value of cell9 is similar to the above (a).

(7) The count value of cell 1 is 1+x, the count values of cell 2, cell 3, and cell 4 are all 1−y, the count values of cell 5, cell 6, cell 7, and cell 8 are all 1, and the count value of cell 9 is 1.

It should be noted that in this case, N_{cells}^{DL,μ}=8+x−3*y and N_{cells}^{DL,μ1}=1, and the determination of the count values of cell1 to cell4 is similar to the above (d), the determination of the count values of cell5 to cell8 is similar to the above (a) and the determination of the count value of cell9 is also similar to the above (a).

(8) The count value of cell1 is 1+x, the count values of cell2, cell3, cell4, cell5, cell6, cell7, and cell8 are all 1−y, and the count value of cell9 is 1.

It should be noted that in this case, N_{cells}^{DL,μ}=8+x−7*y, and N_{cells}^{DL,μ1}=1, and the determination of the count values of cell1 to cell8 is similar to the above (d) and the determination of the count value of cell9 is similar to the above (a).

(9) The count value of cell 1 is 1+x, the count values of cell2, cell3, cell4, cell5, cell6, cell7, and cell8 are all 1−y, and the count value of cell9 is 1−y.

It should be noted that in this case, N_{cells}^{DL,μ}=8+x−7*y and N_{cells}^{DL,μ1}=1−y, and the determination of the count values of cell1 to cell8 is similar to the above (d) and the determination of the count value of cell9 is also similar to the above (d).

It should be understood that when the sum of the count values of the multiple carriers configured by the network device is calculated, that is, when Σⱼ₌₀³(N_{cells}^{DL,j}) is calculated, and when j is taken other values different from μ and μ1, calculation of N_{cells}^{DL,j} is similar to that of cells N_{cells}^{DL,μ} and N_{cells}DL,μ1 cells, i.e., it may also be determined by one of the above methods (1) to (9). For example, when μ=0 and μ1=1, determination of N_{cells}^{DL,2} and N_{cells}^{DL,3} is similar to that of N_{cells}^{DL,0} and N_{cells}^{DL,1} This will not be repeated here.

Based on this, the embodiments of the present disclosure provide a method for determining a detection capability. In the method, a detection capability parameter value for detecting a first DCI format is determined based on a first detection capability parameter value and a second detection capability parameter value, where the first DCI format is used for scheduling multiple carriers in a first carrier set. In this way, the detection capability parameter value for the first DCI format scheduling multiple carriers can be determined based on the first detection capability parameter value and the second detection capability parameter value. As a result, the detection capability for the DCI format (i.e., the first DCI format) scheduling multiple carriers is clarified, which can further optimize the blind detection process of the terminal device. In addition, the terminal device may determine, by using the method, the detection capability parameter value for detecting the first DCI format, such as the number of blind detections, the number of PDCCH candidates for the blind detection, and/or the number of non-overlapping CCEs for channel estimation. The network device determines, by using the method, the detection capability parameter value for detecting the first DCI format by the terminal device, which is helpful for the network device to configure the appropriate number of PDCCH transmission resources, such as the number of CORESETs and/or the number of Search Space Sets. This ensures that the number of PDCCHs that can be transmitted does not exceed the detection capability of the terminal device, thereby improving the system performance.

For example, it can be ensured that the scheduling information is not lost, so that the terminal device can perform data transmission in time. It is ensured that the channel feedback request indication is not lost, so that the terminal device can report the channel state measurement result in time, and the network device can adjust the scheduling parameter in time based on the changing channel state.

In another embodiment of the present disclosure, according to the method for determining the detection capability described in the foregoing embodiments, the embodiments of the present disclosure includes multiple manners for determining the detection capability parameter value for detecting the first DCI format based on the first detection capability parameter value and the second detection capability parameter value.

In some embodiments, the detection capability parameter value for detecting the first DCI format may be determined based on a maximum one of the first detection capability parameter value and the second detection capability parameter value. That is, the detection capability parameter value for detecting the first DCI format may be max (M_max, M_total).

In some embodiments, the detection capability parameter value for detecting the first DCI format may be determined based on a minimum one of the first detection capability parameter value and the second detection capability parameter value. That is, the detection capability parameter value for detecting the first DCI format may be min(M_max, M_total).

In some embodiments, as illustrated in FIG. 3, the method may include the following operation.

In operation S310, the detection capability parameter value for detecting the first DCI format is determined based on the first detection capability parameter value, the second detection capability parameter value, and a first proportionality coefficient. The first proportionality coefficient is configured, or the first proportionality coefficient is predefined by a protocol.

It should be noted that the first proportionality coefficient may be used to determine a proportional relationship of detection capabilities for a second DCI format and the first DCI format.

The second DCI format may be used for scheduling the first carrier, that is, the second DCI format is a DCI format for scheduling one carrier.

A value of the first proportionality coefficient is greater than or equal to 0 and less than or equal to 1.

Here, a is the proportionality coefficient used to determine the detection capability for the first DCI format, and the remaining capability is used to determine the detection capability for the second DCI format. The detection capability for the first DCI format and the detection capability for the second DCI format are allocated according to the configuration (i.e., the first proportionality coefficient), so that the detection capability for the first DCI format and the detection capability for the second DCI format can be clearly allocated, which is beneficial to the realization and optimization of the blind detection process of the terminal.

In one possible implementation, the detection capability parameter value for detecting the first DCI format may be determined based on the minimum one of the first detection capability parameter value and the second detection capability parameter value, and the first proportionality coefficient.

For example, the detection capability parameter value for detecting the first DCI format may be determined based on a product of the minimum one of the first detection capability parameter value and the second detection capability parameter value, and the first proportionality coefficient. The detection capability parameter value for detecting the first DCI format may also be determined based on a quotient of the minimum one of the first detection capability parameter value and the second detection capability parameter value, and the first proportionality coefficient.

In another possible implementation, the detection capability parameter value for detecting the first DCI format may be determined based on the maximum one of the first detection capability parameter value and the second detection capability parameter value, and the first proportionality coefficient.

For example, the detection capability parameter value for detecting the first DCI format may be determined based on a product of the maximum one of the first detection capability parameter value and the second detection capability parameter value, and the first proportionality coefficient. The detection capability parameter value for detecting the first DCI format may also be determined based on a quotient of the maximum one of the first detection capability parameter value and the second detection capability parameter value, and the first proportionality coefficient.

Further, in the embodiments of the present disclosure, the detection capability parameter value for detecting the second DCI format may be determined based on the first detection capability parameter value, the second detection capability parameter value, and a second proportionality coefficient. The sum of the second proportionality coefficient and the first proportionality coefficient is 1.

Exemplarily, the first detection capability parameter value is denoted as M_max, the second detection capability parameter value is denoted as M_total, the first proportionality coefficient is a, and the second proportionality coefficient is 1-a. Then the terminal device or the network device may determine that the detection capability parameter value for detecting the first DCI format may be a part of the minimum one of M_max and M_total, that is, a*(min (M_max, M_total)). In this case, the terminal device or the network device may determine that the detection capability parameter value for detecting the second DCI format may be (1−a)*min (M_max, M_total).

In the method for determining the detection capability provided by the embodiments of the present disclosure, the detection capability parameter value for detecting the first DCI format can be determined based on the first detection capability parameter value, the second detection capability parameter value and the first proportionality coefficient, where the first DCI format is used for scheduling multiple carriers in the first carrier set. In this way, the detection capability parameter value for the first DCI format scheduling multiple carriers can be determined based on the first detection capability parameter value, the second detection capability parameter value and the first proportionality coefficient. Thus, the detection capability for the DCI format (i.e., the first DCI format) scheduling multiple carriers is clarified and the detection capability for the DCI format (i.e., the second DCI format) scheduling the single carrier is clarified, so that the first DCI format scheduling multiple carriers and the second DCI format scheduling one carrier can be distinguished, which is beneficial to the realization and optimization of the blind detection process of the terminal. In addition, the terminal device may determine, by using the method, the detection capability parameter value for detecting the first DCI format, such as the number of blind detections, the number of PDCCH candidates for the blind detection, and/or the number of non-overlapping CCEs for channel estimation. The network device determines, by using the method, the detection capability parameter value for detecting the first DCI format, which is helpful for the network device to configure the appropriate number of PDCCH transmission resources, such as the number of CORESETs, the number of Search Space Sets or the number of PDCCH candidates. This ensures that the number of PDCCHs that can be transmitted does not exceed the detection capability of the terminal device, thereby avoiding situations that some PDCCHs cannot be detected due to an insufficient detection capability of the terminal device, and improving the system performance.

For example, it is ensured that the scheduling information is not lost, so that the terminal device can perform data transmission in time. It is ensured that the channel feedback request indication is not lost, so that the terminal device can report the channel state measurement result in time, and thus the network device can adjust the scheduling parameters based on the changing channel state in time. In the embodiments of the present disclosure, the carrier(s) simultaneously scheduled by the DCI formats 0_X and/or 1_X may be at least one carrier in a set composed of multiple carriers, and the set composed of the multiple carriers may be the first carrier set.

Exemplarily, the configuration of the carriers simultaneously scheduled by DCI formats 0_X and/or 1_X may be illustrated in two examples as follows.

In the first example, the first carrier set is {cell1, cell2, cell3, cell4, cell5, cell6, cell7, cell8}, and the configuration of the carriers simultaneously scheduled by the DCI formats 0_X and/or 1_X is shown in Table 1.

TABLE 1

| Index serial number | Configuration of carriers |
|---|---|
| 1 | cell1 + cell2 |
| 2 | cell3 + cell4 |
| 3 | cell1 + cell2 + cell3 |
| 4 | cell2 + cell3 + cell4 |
| 5 | cell5 + cell6 |
| 6 | cell6 + cell7 |
| 7 | cell7 + cell8 |
| 8 | cell5 + cell8 |
| 9 | cell5 + cell7 |
| 10 | cell6 + cell8 |
| 11 | cell5 + cell6 + cell7 |
| 12 | cell6 + cell7 + cell8 |

In the second example, the first carrier set is {cell1, cell2, cell3, cell4}, and the configuration of the carriers simultaneously scheduled by the DCI formats 0_X and/or 1_X is shown in Table 2.

TABLE 2

| Index serial number | Configuration of carriers |
|---|---|
| 1 | cell1 + cell2 |
| 2 | cell3 + cell4 |
| 3 | cell1 + cell2 + cell3 |
| 4 | cell2 + cell3 + cell4 |

In the embodiments of the present disclosure, when the terminal device or the network device counts the blind detection capability of the DCI/PDCCH for scheduling multiple carriers on one carrier, the detection capability parameter value allocated for detecting the DCI/PDCCH scheduling multiple carriers and the detection capability parameter value allocated for detecting the DCI/PDCCH scheduling one carrier can be distinguished, that is, the single-carrier scheduling detection capability parameter value and the multi-carrier scheduling detection capability parameter value can be distinguished. Moreover, the numbers of blind detections, the numbers of PDCCH candidates for blind detection, and/or the numbers of non-overlapping CCEs for channel estimation corresponding to different DCI formats can be clarified for the terminal device or the network device; and the network device configures the appropriate number of PDCCH transmission resources, so that the number of PDCCHs that can be transmitted does not exceed the detection capability of the terminal device.

In addition, when the terminal device or the network device determines the detection capability parameter thresholds of the scheduling carriers with different subcarrier spacings, methods for determining the count values of the multiple carriers configured by the network device can be clarified. The methods for determining the count values of the multiple carriers includes the methods for determining the count value of the scheduling carrier. According to the methods in the embodiments of the present disclosure, different methods for determining the count value of the scheduling carrier have different influences on the detection capability parameter values of other carriers except the scheduling carrier. Therefore, the influence of the detection capability parameter value of the scheduling carrier on the detection capabilities of other carriers can be controlled by clarifying the detection capability parameter value for the DCI format (i.e., the first DCI format) scheduling the multiple carriers.

The preferred embodiments of the present disclosure have been described in detail above with reference to the accompanying drawings, but the present disclosure is not limited to the specific details in the above embodiments. Within the scope of the technical concept of the present disclosure, various simple modifications may be made to the technical solutions of the present disclosure, and these simple modifications all fall within the scope of protection of the present disclosure. For example, various specific technical features described in the above detailed embodiments may be combined in any suitable manner without contradiction, and various possible combinations will not be described separately in the present disclosure in order to avoid unnecessary repetition. For another example, various different embodiments of the present disclosure may be combined arbitrarily, and as long as the combinations do not violate the idea of the present disclosure, and they should also be regarded as the disclosure of the present disclosure. For another example, on the premise that there is no conflict, various embodiments described in the present disclosure and/or the technical features in various embodiments may be arbitrarily combined with the prior art, and the technical solutions obtained after the combination should also fall within the scope of protection of the present disclosure.

It should also be understood that in various method embodiments of the present disclosure, the sizes of the sequence numbers of the above processes do not mean the sequence of execution, and the sequence of execution of various processes should be determined by their functions and internal logics, and should not constitute any limitation on the implementation of the embodiments of the present disclosure.

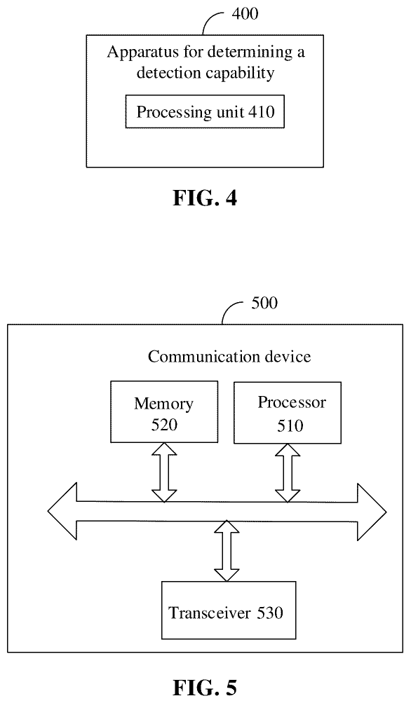

FIG. 4 is a schematic diagram of a structural composition of an apparatus for determining a detection capability according to an embodiment of the present disclosure. The apparatus is applied to a terminal device or a network device. As illustrated in FIG. 4, the apparatus 400 for determining a detection capability includes a processing unit 410.

The processing unit 410 is configured to determine, based on a first detection capability parameter value and a second detection capability parameter value, a detection capability parameter value for detecting a first DCI format. The first DCI format is used for scheduling multiple carriers in a first carrier set.

The first detection capability parameter value is a single carrier detection capability parameter threshold corresponding to a first carrier. The first carrier is included in the first carrier set.

The second detection capability parameter value is a detection capability parameter threshold for detecting a DCI format scheduling carrier(s) in a second carrier set. The second carrier set includes the first carrier set.

In some embodiments, the second detection capability parameter value is determined based on a number of carriers that are supported for detection, the single carrier detection capability parameter threshold, a first value, and a second value.

The first value is determined based on a carrier quantity corresponding to the second carrier set, and the carrier quantity is determined based on count values of carriers.

The second value is determined based on a carrier quantity of configured multiple carriers, the carrier quantity is determined based on count values of the carriers, and the configured multiple carriers include the second carrier set.

In some embodiments, a count value of the first carrier is 1+x.

In some embodiments, count values of other carriers, other than the first carrier, in the configured multiple carriers are determined according to any one of: the count values are all 1−y, the count values are all 1−x/(M−1), or the count values are all 1−x/(N−1).

Here, M is the number of carriers in the first carrier set, and N is the number of the configured multiple carriers.

In some embodiments, a count value of the first carrier set is x.

In some embodiments, the count values of the configured multiple carriers are determined according to any one of: the count values are all 1−y, the count values are all 1−x/M, or the count values are all 1−x/N.

Here, M is the number of carriers in the first carrier set, and N is the number of the configured multiple carriers.

In some embodiments, a value of x satisfies 0<=x<=1, and/or, a value of y satisfies 0<=y<=1.

In some embodiments, the other carriers are any one of: carriers, other than the first carrier, in the first carrier set; carriers, other than the first carrier, in the second carrier set; or carriers, other than the first carrier, in the configured multiple carriers.

In some embodiments, the first detection capability parameter value is determined based on a subcarrier spacing of the first carrier, or the first detection capability parameter value is determined based on a subcarrier spacing of a scheduling carrier for the first carrier.

In some embodiments, the first carrier is any one of the following in the first carrier set: a carrier with ID information being a specified ID, a carrier whose number of configured search space sets satisfies a first preset rule, a carrier whose number of search space sets supporting single carrier scheduling satisfies a second preset rule, a carrier configured for calculating the detection capability parameter value for the first DCI format, a carrier configured with a search space set supporting the first DCI format, a carrier counting a DCI size of the first DCI format, or a carrier predefined by a protocol.

In some embodiments, subcarrier spacings of scheduling carriers for carriers in the second carrier set are same.

In some embodiments, the processing unit 410 is configured to determine, based on a minimum one of the first detection capability parameter value and the second detection capability parameter value, the detection capability parameter value for detecting the first DCI format.

In some embodiments, the processing unit 410 is further configured to determine, based on the first detection capability parameter value, the second detection capability parameter value, and a first proportionality coefficient, the detection capability parameter value for detecting the first DCI format. The first proportionality coefficient is configured, or the first proportionality coefficient is predefined by a protocol.

In some embodiments, the processing unit 410 is further configured to determine, based on a minimum one of the first detection capability parameter value and the second detection capability parameter value, and the first proportionality coefficient, the detection capability parameter value for detecting the first DCI format.

In some embodiments, the processing unit 410 is further configured to determine, based on a product of the minimum one of the first detection capability parameter value and the second detection capability parameter value, and the first proportionality coefficient, the detection capability parameter value for detecting the first DCI format.

In some embodiments, a value of the first proportionality coefficient is greater than or equal to 0 and less than or equal to 1.

The apparatus for determining the detection capability provided by the embodiments of the present disclosure can determine a detection capability parameter value for detecting a first DCI format based on a first detection capability parameter value and a second detection capability parameter value, where the first DCI format is used for scheduling multiple carriers in a first carrier set. In this way, the detection capability parameter value for the first DCI format that can schedule multiple carriers can be determined based on the first detection capability parameter value and the second detection capability parameter value. Thus, the detection capability for the DCI format (i.e., the first DCI format) scheduling multiple carriers is clarified, which can further optimize the blind detection process of the terminal device. In addition, the terminal device can determine, by using the method, the detection capability parameter value for detecting the first DCI format, such as the number of blind detections, the number of PDCCH candidates for the blind detection, and/or the number of non-overlapping CCEs for channel estimation. The network device determines, by using the method, the detection capability parameter value for detecting the first DCI format, which is helpful for the network device to configure an appropriate number of PDCCH transmission resources, such as the number of CORESETs, the number of Search Space Sets and the number of PDCCH candidates, so that the number of PDCCHs that can be transmitted does not exceed the detection capability of the terminal device, thereby avoiding situations that some PDCCHs cannot be detected due to an insufficient detection capability of terminal device, and improving the system performance.

Those skilled in the art should understand that the related description of the above apparatuses for determining the detection capability according to the embodiments of the present disclosure may be understood with reference to the related description of the methods for determining the detection capability according to the embodiments of the present disclosure.

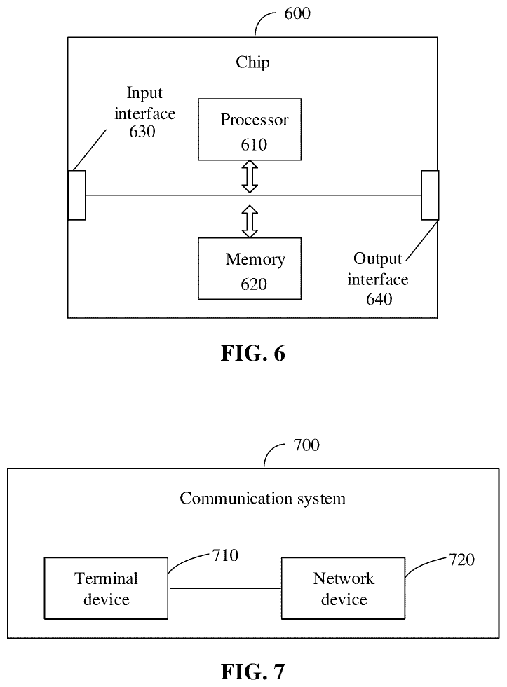

FIG. 5 is a schematic structural diagram of a communication device 500 according to an embodiment of the present disclosure. The communication device may be a terminal device or a network device. The communication device 500 illustrated in FIG. 5 includes a processor 510. The processor 510 may invoke and execute a computer program from a memory to implement the methods in the embodiments of the present disclosure.

In some embodiments, as illustrated in FIG. 5, the communication device 500 may further include a memory 520. The processor 510 may invoke and execute the computer program from the memory 520 to implement the methods in the embodiments of the present disclosure.

The memory 520 may be a separate device independent of the processor 510 or may be integrated in the processor 510.

In some embodiments, as illustrated in FIG. 5, the communication device 500 may further include a transceiver 530. The processor 510 may control the transceiver 530 to communicate with other devices, specifically, may transmit information or data to other devices, or may receive information or data transmitted by other devices.

The transceiver 530 may include a transmitter and a receiver. The transceiver 530 may further include one or more antennas.

In some embodiments, the communication device 500 may specifically be the network device in the embodiments of the present disclosure, and the communication device 500 may implement corresponding processes implemented by the network device in various methods of the embodiments of the present disclosure, which will not be described herein for the sake of brevity.

In some embodiments, the communication device 500 may specifically be the terminal device in the embodiments of the present disclosure, and the communication device 500 may implement corresponding processes implemented by the terminal device in various methods of the embodiments of the present disclosure, which will not be described herein for the sake of brevity.

FIG. 6 is a schematic structural diagram of a chip according to an embodiment of the present disclosure. The chip 600 illustrated in FIG. 6 includes a processor 610, and the processor 610 may invoke and execute a computer program from a memory to implement the methods in the embodiments of the present disclosure.

In some embodiments, as illustrated in FIG. 6, the chip 600 may further include a memory 620. The processor 610 may invoke and execute a computer program from the memory 620 to implement the methods in the embodiments of the present disclosure.

The memory 620 may be a separate device independent of the processor 610 or may be integrated in the processor 610.

In some embodiments, the chip 600 may further include an input interface 630. The processor 610 may control the input interface 630 to communicate with other devices or chips, specifically, may acquire information or data transmitted by other devices or chips.

In some embodiments, the chip 600 may further include an output interface 640. The processor 610 may control the output interface 640 to communicate with other devices or chips, specifically, may output information or data to other devices or chips.

In some embodiments, the chip may be applied to the network device in the embodiments of the present disclosure, and the chip may implement the corresponding processes implemented by the network device in various methods of the embodiments of the present disclosure, which will not be described herein for the sake of brevity.

In some embodiments, the chip may be applied to the terminal device in the embodiments of the present disclosure, and the chip may implement the corresponding processes implemented by the terminal device in various methods of the embodiments of the present disclosure.

It should be understood that the chip mentioned in the embodiment of the present disclosure may be referred as a system level chip, a system chip, a chip system or a system-on-chip or the like.

FIG. 7 is a schematic block diagram of a communication system 700 according to an embodiment of the present disclosure. As illustrated in FIG. 7, the communication system 700 includes the terminal device 710 and the network device 720.

The terminal device 710 may be configured to implement the corresponding functions implemented by the terminal device in the above methods, and the network device 720 may be configured to implement the corresponding functions implemented by the network device in the above methods, which will not be described herein for the sake of brevity.

It should be understood that the processor of the embodiments of the present disclosure may be an integrated circuit chip having signal processing capabilities. In the implementation process, the operations of the above method embodiments may be completed by integrated logic circuits of hardware in the processor or instructions in the form of software. The processor described above may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, operations, and logical block diagrams disclosed in the embodiments of the present disclosure may be implemented or executed. The general-purpose processor may be a microprocessor or the processor may be any conventional processor or the like. The operations of the methods disclosed in combination with the embodiments of the present disclosure may be directly embodied as execution by the hardware decoding processor, or may be executed by a combination of hardware and software modules in the decoding processor. The software module may be located in a Random Access Memory (RAM), a flash memory, a Read-Only Memory (ROM), a Programmable ROM (PROM), an electrically erasable PROM (EEPROM), a register and other storage medium mature in the art. The storage medium is located in the memory, and the processor reads the information in the memory and completes the operations of the methods in combination with its hardware.

It is understood that the memory in the embodiments of the present disclosure may be a volatile memory or a non-volatile memory, or may include both volatile and non-volatile memory. The non-volatile memory may be a ROM, a PROM, an Erasable PROM (EPROM), an EEPROM, or a flash memory. The volatile memory may be a RAM, which serves as an external cache. By way of illustration, but not limitation, many forms of RAMs are available, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM) and Direct Rambus RAM (DR RAM). It should be noted that the memory of the systems and methods described herein is intended to include, but is not limited to, these and any other suitable type of memory.

It should be understood that the above memory is exemplary, but not limiting. For example, the memory in embodiments of the present disclosure may also be an SRAM, a DRAM, an SDRAM, a DDR SDRAM, an ESDRAM, an SLDRAM, a DR RAM, or the like. That is, the memory in embodiments of the present disclosure is intended to include but not limited to these and any other suitable types of memory.

Embodiments of the present disclosure further provide a computer readable storage medium for storing a computer program.

In some embodiments, the computer readable storage medium may be applied to the network device in the embodiments of the present disclosure, and the computer program causes the computer to execute the corresponding processes implemented by the network device in various methods of the embodiments of the present disclosure, which will not be described herein for the sake of brevity.

In some embodiments, the computer readable storage medium may be applied to the terminal device in the embodiments of the present disclosure, and the computer program causes the computer to execute the corresponding processes implemented by the terminal device in various methods of the embodiments of the present disclosure, which will not be described herein for the sake of brevity.

Embodiments of the present disclosure further provide a computer program product including computer program instructions.

In some embodiments, the computer program product may be applied to the network device in the embodiments of the present disclosure, and the computer program instructions cause the computer to execute the corresponding processes implemented by the network device in various methods of the embodiments of the present disclosure, which will not be described herein for the sake of brevity.

In some embodiments, the computer program product may be applied to the terminal device in the embodiments of the present disclosure, and the computer program instruction causes the computer to execute the corresponding processes implemented by the terminal device in various methods of the embodiments of the present disclosure, which will not be described herein for the sake of brevity.

Embodiments of the present disclosure further provide a computer program.

In some embodiments, the computer program may be applied to the network device in the embodiments of the present disclosure, and when the computer program is executed on the computer, the computer executes the corresponding processes implemented by the network device in various methods of the embodiments of the present disclosure, which will not be described herein for the sake of brevity.

Alternatively, the computer program may be applied to the terminal device in the embodiments of the present disclosure, and when the computer program is executed on the computer, the computer executes the corresponding processes implemented by the terminal device in various methods of the embodiments of the present disclosure, which will not be described herein for the sake of brevity.

Those of ordinary skill in the art will appreciate that the various exemplary units and algorithm operations described in combination with the embodiments disclosed herein may be implemented in electronic hardware or a combination of computer software and electronic hardware. Whether these functions are performed in hardware or software depends on the specific application and design constraints of the technical solutions. Professionals may use different methods for each particular application to implement the described functionality, but such implementation should not be considered outside the scope of the present disclosure.

Those skilled in the art will clearly appreciate that for convenience and conciseness of description, the specific operating processes of the above described systems, apparatuses and units may be understood with reference to the corresponding processes in the aforementioned method embodiments, which will not be described herein for the sake of brevity.

In several embodiments provided herein, it should be understood that the disclosed systems, apparatuses and methods may be implemented in other ways. For example, the above embodiments of the apparatuses are only schematic, for example, the division of the units is only a logical function division, and in practice, there may be another division manner, for example, multiple units or components may be combined or integrated into another system, or some features may be ignored or not performed. On the other hand, the coupling, direct coupling or communication connection between each other shown or discussed may be indirect coupling or communication connection through some interfaces, apparatus or units, and may be electrical, mechanical or other forms.

The units illustrated as separate components may or may not be physically separated, and the components displayed as units may or may not be physical units, i.e., may be located in one place, or may be distributed over multiple network units. Part or all of the units may be selected according to the actual needs to achieve the purpose of the embodiments.

In addition, various functional units in various embodiments of the present disclosure may be integrated in one processing unit, or each unit may exist physically alone, or two or more units may be integrated in one unit.

When implemented in the form of software functional units, and sold or used as stand-alone products, the functions may be stored in a computer readable storage medium. With this understanding, the technical solution of the present disclosure in essence or the part contributing to the prior art or the part of the technical solution may be embodied in the form of a software product. The computer software product is stored in a storage medium, and includes instructions for causing a computer device (which may be a personal computer, a server, a network device, or the like) to perform all or part of the operations of the methods described in various embodiments of the present disclosure. The above storage medium includes a U disk, a removable hard disk, a ROM, a RAM, a magnetic disk or an optical disk and other medium capable of storing program codes.

The above is merely the specific embodiments of the present disclosure, but the scope of protection of the present disclosure is not limited thereto. Any changes or changes or substitutions that can be easily conceived by those skilled in the art within the technical scope disclosed in the present disclosure should be covered within the scope of protection of the present disclosure. Therefore, the scope of protection of the present disclosure shall be subject to the scope of protection of the claims.

1. A method for determining a detection capability, comprising:
determining, based on a first detection capability parameter value and a second detection capability parameter value, a detection capability parameter value for detecting a first Downlink Control Information (DCI) format, the first DCI format being used for scheduling a plurality of carriers in a first carrier set,
wherein the first detection capability parameter value is a single carrier detection capability parameter threshold corresponding to a first carrier, the first carrier being comprised in the first carrier set; and
the second detection capability parameter value is a detection capability parameter threshold for detecting a DCI format scheduling carrier(s) in a second carrier set, the second carrier set comprising the first carrier set.

2. The method of claim 1, wherein the second detection capability parameter value is determined based on a number of carriers that are supported for detection, the single carrier detection capability parameter threshold, a first value, and a second value; wherein
the first value is determined based on a carrier quantity corresponding to the second carrier set, the carrier quantity corresponding to the second carrier set being determined based on count values of carriers included in the second carrier set; and
the second value is determined based on a carrier quantity of a plurality of configured carriers, the carrier quantity of the plurality of configured carriers being determined based on count values of the plurality of configured carriers, and the plurality of configured carriers comprising the second carrier set.

3. The method of claim 2, wherein a count value of the first carrier is 1+x, 0<=x<=1; and
wherein count values of other carriers, other than the first carrier, in the plurality of configured carriers are determined according to any one of:
the count values are all 1−y, 0<=y<=1;
the count values are all 1−x/(M−1); or
the count values are all 1−x/(N−1);
wherein M is a number of carriers in the first carrier set, and N is a number of the plurality of configured carriers.

4. The method of claim 2, wherein a count value of the first carrier set is x, 0<=x<=1; and
wherein the count values of the plurality of configured carriers are determined according to any one of:
the count values are all 1−y, 0<=y<=1;
the count values are all 1−x/M; or
the count values are all 1−x/N;
wherein M is a number of carriers in the first carrier set, and N is a number of the plurality of configured carriers.

5. The method of claim 1, wherein the first detection capability parameter value is determined based on a subcarrier spacing of the first carrier, or the first detection capability parameter value is determined based on a subcarrier spacing of a scheduling carrier for the first carrier.

6. The method of claim 1, wherein the first carrier is any one of following in the first carrier set:
a carrier with Identity (ID) information being a specified ID;
a carrier whose number of configured search space sets satisfies a first preset rule;
a carrier whose number of search space sets supporting single carrier scheduling satisfies a second preset rule;
a carrier configured for calculating the detection capability parameter value for the first DCI format;
a carrier configured with a search space set supporting the first DCI format;
a carrier counting a DCI size of the first DCI format; or
a carrier predefined by a protocol.

7. The method of claim 1, wherein subcarrier spacings of scheduling carriers for carriers in the second carrier set are same.

8. The method of claim 1, wherein determining, based on the first detection capability parameter value and the second detection capability parameter value, the detection capability parameter value for detecting the first DCI format comprises:
determining, based on a minimum one of the first detection capability parameter value and the second detection capability parameter value, the detection capability parameter value for detecting the first DCI format.

9. The method of claim 1, wherein determining, based on the first detection capability parameter value and the second detection capability parameter value, the detection capability parameter value for detecting the first DCI format comprises:
determining, based on the first detection capability parameter value, the second detection capability parameter value, and a first proportionality coefficient, the detection capability parameter value for detecting the first DCI format, wherein the first proportionality coefficient is configured, or the first proportionality coefficient is predefined by a protocol.

10. An apparatus for determining a detection capability, comprising:
a processor; and
a memory for storing a computer program that, when executed by the processor, causes the apparatus to determine, based on a first detection capability parameter value and a second detection capability parameter value, a detection capability parameter value for detecting a first Downlink Control Information (DCI) format, the first DCI format being used for scheduling a plurality of carriers in a first carrier set,
wherein the first detection capability parameter value is a single carrier detection capability parameter threshold corresponding to a first carrier, the first carrier being comprised in the first carrier set; and
the second detection capability parameter value is a detection capability parameter threshold for detecting a DCI format scheduling carrier(s) in a second carrier set, the second carrier set comprising the first carrier set.

11. The apparatus of claim 10, wherein the second detection capability parameter value is determined based on a number of carriers that are supported for detection, the single carrier detection capability parameter threshold, a first value, and a second value; wherein
the first value is determined based on a carrier quantity corresponding to the second carrier set, the carrier quantity corresponding to the second carrier set being determined based on count values of carriers included in the second carrier set; and
the second value is determined based on a carrier quantity of a plurality of configured carriers, the carrier quantity of the plurality of configured carriers being determined based on count values of the plurality of configured carriers, and the plurality of configured carriers comprising the second carrier set.

12. The apparatus of claim 11, wherein a count value of the first carrier is 1+x, 0<=x<=1; and wherein count values of other carriers, other than the first carrier, in the plurality of configured carriers are determined according to any one of:
the count values are all 1−y, 0<=y<=1;
the count values are all 1−x/(M−1); or
the count values are all 1−x/(N−1);
wherein M is a number of carriers in the first carrier set, and N is a number of the plurality of configured carriers.

13. The apparatus of claim 11, wherein a count value of the first carrier set is x, 0<=x<=1; and
wherein the count values of the plurality of configured carriers are determined according to any one of:
the count values are all 1−y, 0<=y<=1;
the count values are all 1−x/M; or
the count values are all 1−x/N;
wherein M is a number of carriers in the first carrier set, and N is a number of the plurality of configured carriers.

14. The apparatus of claim 12, wherein the other carriers are any one of:
carriers, other than the first carrier, in the first carrier set;
carriers, other than the first carrier, in the second carrier set; or
carriers, other than the first carrier, in the plurality of configured carriers.

15. The apparatus of claim 10, wherein the first carrier is any one of following in the first carrier set:
a carrier with Identity (ID) information being a specified ID;
a carrier whose number of configured search space sets satisfies a first preset rule;
a carrier whose number of search space sets supporting single carrier scheduling satisfies a second preset rule;
a carrier configured for calculating the detection capability parameter value for the first DCI format;
a carrier configured with a search space set supporting the first DCI format;
a carrier counting a DCI size of the first DCI format; or
a carrier predefined by a protocol.

16. The apparatus of claim 10, wherein subcarrier spacings of scheduling carriers for carriers in the second carrier set are same.

17. The apparatus of claim 10, wherein the processor is further configured to execute the computer program to cause the apparatus to determine, based on a minimum one of the first detection capability parameter value and the second detection capability parameter value, the detection capability parameter value for detecting the first DCI format.

18. The apparatus of claim 10, wherein the processor is further configured to execute the computer program to cause the apparatus to determine, based on the first detection capability parameter value, the second detection capability parameter value, and a first proportionality coefficient, the detection capability parameter value for detecting the first DCI format, wherein the first proportionality coefficient is configured, or the first proportionality coefficient is predefined by a protocol.

19. The apparatus of claim 18, wherein the processor is further configured to execute the computer program to cause the apparatus to determine, based on a minimum one of the first detection capability parameter value and the second detection capability parameter value, and the first proportionality coefficient, the detection capability parameter value for detecting the first DCI format.

20. A non-transitory computer readable storage medium for storing a computer program that, when executed by a processor of a communication device, causes the communication device to perform a method for determining a detection capability comprising:
determining, based on a first detection capability parameter value and a second detection capability parameter value, a detection capability parameter value for detecting a first Downlink Control Information (DCI) format, the first DCI format being used for scheduling a plurality of carriers in a first carrier set,
wherein the first detection capability parameter value is a single carrier detection capability parameter threshold corresponding to a first carrier, the first carrier being comprised in the first carrier set; and
the second detection capability parameter value is a detection capability parameter threshold for detecting a DCI format scheduling carrier(s) in a second carrier set, the second carrier set comprising the first carrier set.
